(19) United States
(12) Patent Application Publication
(10) Pub. No.: US 2020/0221667 A1
(43) Pub. Date: Jul. 16, 2020

(54) DIGITALLY CONTROLLED ALTERNATING PRESSURE GARMENT

(71) Applicant: David Duff, Medford, MA (US)

(72) Inventor: David Duff, Medford, MA (US)

(21) Appl. No.: 16/740,882

(22) Filed: Jan. 13, 2020

Related U.S. Application Data
(60) Provisional application No. 62/792,414, filed on Jan. 15, 2019.
(60) Provisional application No. 62/855,269, filed on May 31, 2019.

(51) Int. Cl. A01K 13/00; A01K 29/00; G08C 17/02

(52) U.S. Cl. CPC A01K 13/006; G08C 17/02; A01K 29/005

(57) ABSTRACT

Techniques for reducing anxiety in domestic animal are provided. An example of an alternating pressure garment according to the disclosure includes a fabric shell configured to fit around at least a portion of a companion animal, a plurality of bladders disposed between the fabric shell and the companion animal, and a pressurizing module fluidly coupled to the plurality of bladders and configured to alternately pressurize at least a first group of the plurality of bladders and a second group of the plurality bladders.

### CROSS-REFERENCE TO RELATED APPLICATIONS

This application claims the benefit of U.S. Provisional Application No. 62/792,414, filed Jan. 15, 2019, “DIGITALLY CONTROLLED CHEMICAL DISPERSAL DEVICE,” and U.S. Provisional Application No. 62/855,269, filed May 31, 2019, entitled “DIGITALLY CONTROLLED ALTERNATING PRESSURE GARMENT,” the entire contents of which are hereby incorporated herein by reference for all purposes.

### BACKGROUND

Canine anxiety is known to exist in one form or another for more than 50% of the approximately 80 million dogs in the United States. The anxiety is triggered by several known factors including separation from their owners, loud noises such as thunder and fireworks, and negatively associated places such as cars and veterinarian offices. Up to 50% of dogs have been reported by their owners to be anxious due to at least one source of noise or another. Anxiety treatment is usually accomplished via pheromones, de-sensitizing, medication, or combinations of the three with little to partial success. In the case of separation anxiety, dogs which do not receive or respond to treatment are often brought to shelters, abandoned, or euthanized by their owners.

### SUMMARY

An example of an alternating pressure garment according to the disclosure includes a fabric shell configured to fit around at least a portion of a companion animal, one or more fasteners configured to secure the fabric shell around the companion animal, a plurality of bladders disposed between the fabric shell and the companion animal, and a pressurizing module fluidly coupled to the plurality of bladders and configured to alternately pressurize at least a first group of the plurality of bladders and a second group of the plurality bladders, such that the first group of the plurality of bladders is in an inflated state and the second group of the plurality of bladders is in a deflated state or the first group of the plurality of bladders is in a deflated state and the second group of the plurality of bladders is in an inflated state.

Implementations of such an alternating pressure garment may include one or more of the following features. One or more pressure sensors may be operably coupled to the pressurizing module and configured to sense a pressure between one or more of the plurality of bladders and the companion animal. One or more pressure sensors may be operably coupled to the pressurizing module and configured to sense an air pressure in one or more of the plurality of bladders. The pressurizing module may be configured to generate a vacuum pressure to deflate one or more of the plurality of bladders. One or more bleed valves may be configured to release pressure from the plurality of bladders. The pressurizing module may include a control unit configured to alternately pressurize the plurality of bladders based on one or more pressure functions. The pressure functions may cause the first group of the plurality of bladders and the second group of the plurality of bladders to alternately inflate and deflate periodically. The pressure functions may cause the first group of the plurality of bladders and the second group of the plurality of bladders to alternately inflate and deflate randomly. The control unit further may include a wireless communication module configured to receive the one or more pressure functions via a wireless network.

An example of a method for reducing anxiety in a companion animal with an alternating pressure garment according to the disclosure includes detecting one or more anxiety factors, determining an alternating pressure profile based at least in part on the one or more anxiety factors, and activating a pressurizing module in the alternating pressure garment based on the alternating pressure profile.

Implementations of such a method may include one or more of the following features. The one or more anxiety factors may be associated with the companion animal. The one or more anxiety factors may be determined from one of a group consisting of a motion sensor, a heart-beat sensor, and a microphone. The one or more anxiety factors may be associated with an environment around the companion animal. The one or more anxiety factors may be determined from one of a group consisting of a weather station, a microphone, and a user input. Determining the alternating pressure profile may include querying a data structure based on the one or more anxiety factors. Determining the alternating pressure profile may include receiving a custom profile from a user. Activating the pressurizing module may include alternately inflating and deflating a first group of bladders in the alternating pressure garment, and alternately inflating and deflating at least a second group of bladders in the alternating pressure garment, such that the first group of bladders is inflated when at least the second group of bladders is deflated.

An example of a system for setting pump parameters for an alternating pressure garment according to the disclosure includes a memory, at least one processor operably coupled to the memory and configured to determine an application value associated with a utilization of the alternating pressure garment, determine one or more environment values associated with the utilization of the alternating pressure garment, determine an activity value associated with the utilization of the alternating pressure garment, and set pump timing parameters based at least in part on the application value, the one or more environment values, or the activity value.

Implementations of such a system may include one or more of the following features. A communication module may be operably coupled to the processor and configured to receive the application value, the one or more environment values, or the activity value via a network. The communication module may be configured to provide the pump timing parameters to the network.

An example of an alternating pressure garment according to the disclosure includes a fabric or polymeric shell configured to fit around at least a portion of a companion animal, one or more fasteners configured to secure the fabric shell around the companion animal, a plurality of bladders disposed between the fabric shell and the companion animal, and a pressurizing module fluidly coupled to the plurality of bladders and configured to alternately pressurize and depressurize the plurality of bladders.

Implementations of such an alternating pressure garment may include one or more of the following features. The pressurizing module may include a control unit configured to alternately pressurize the plurality of bladders based on one or more pressure functions. The pressure functions may cause the plurality of bladders to alternately inflate and deflate periodically. The pressure functions may cause the plurality of bladders to alternately inflate and deflate randomly. The control unit may include a wireless communication module configured to receive the one or more pressure functions via a wireless network.

An example of a pressure garment according to the disclosure includes a fabric or polymeric shell configured to fit around at least a portion of a companion animal, a plurality of bladders disposed between the fabric shell and the companion animal, and a pressurizing module fluidly coupled to the plurality of bladders and configured to pressurize the plurality of bladders.

Items and/or techniques described herein may provide one or more of the following capabilities, as well as other capabilities not mentioned. A garment may be worn by a domestic animal such as a dog. The garment may have a flexible fabric layer and one or more fasteners to secure the garment around the dog. One or more bladders configured to be inflated and deflated may be disposed between the fabric layer and the dog. A pressurizing module may include one or more pumps configured to inflate or deflate the bladders. One or more of the bladders may be inflated to generate a comforting pressure on the dog. One or more of the bladders may be alternately inflated and deflated to limit the sensory adaptation experienced by the dog. The pressurizing module may be controlled locally or remotely. The pressurizing module may include a memory unit configured to store one or more pressure functions to control the inflation and deflation of the bladders. Pressure functions may be sent and received from a network. An anxiety level of the dog may be detected by one or more local or remote sensors. The anxiety level may be used to control the pressurizing module. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

### BRIEF DESCRIPTION OF THE DRAWINGS

FIG. 1 is an example of a digitally controlled alternating pressure garment being worn by a companion animal.

FIG. 2 is a top view of an example digitally controlled alternating pressure garment.

FIG. 3 is a bottom view of an example digitally controlled alternating pressure garment.

FIGS. 4A, 4B, and 4C are cross-section views of an example digitally controlled alternating pressure garment in a deflated state and partially inflated states due to selective inflation and deflation of a subset of bladders.

FIG. 5 is a cross-section view of an example digitally controlled alternating pressure garment disposed on a companion animal.

FIG. 6A is a system diagram of an example digitally controlled alternating pressure distribution system with optional pressure sensors.

FIG. 6B is a system diagram of an example digitally controlled alternating pressure distribution system.

FIG. 7 is an example of pump states and alternating pressure functions.

FIG. 8 is an example of a data structure for controlling a digitally controlled alternating pressure garment.

FIG. 9 is a system architecture diagram of an example network for exchanging data with digitally controlled alternating pressure garments.

FIG. 10A is an example process flow for setting pump timing parameters in a digitally controlled alternating pressure garment.

FIG. 10B is an example process flow for activating an alternating pressure garment.

FIG. 11 is a block diagram of an example computer system.

FIG. 12 is a block diagram of an example control unit in a digitally controlled alternating pressure garment.

### DETAILED DESCRIPTION

Techniques are discussed herein for reducing anxiety in domestic animals. For example, in an example, a digitally controlled alternating pressure garment includes an affixing hook and loop features for securing the garment on an animal, a pressurizing system, and a digital control module capable of monitoring the environment, the activity, or the physiological state of the animal. The alternating pressure garment may contain an embedded single air bladder or a plurality of embedded air bladders which are in fluid connection to a pressurizing system. The pressurizing system may function in either a positive pressure generation mode or a negative pressure mode (e.g., vacuum assisted or bleeding off extant pressure). There may contain a manifold between the pressurizing system and the air bladders. Inflation and deflation of the air bladders are controlled by a digital control module. The digital control module may include sensors for monitoring the activity, the environment, or the physiological state of the device wearer. The digital control module may contain communication capability such as WiFi, Bluetooth, cellular (e.g., LTE, 5G), or other methods to connect to external devices and the internet. The digital control module, based on certain appropriate signal parameters, can then induce specific inflation and deflation cycling for the embedded air bladders. The digital control module may also contain a power source in the form of a battery, a manual on/off switch, and associated digital components required to comprise the overall electronic function of the alternating pressure garment. The digital control module may have an associated communication module to enable WiFi, Bluetooth, cellular or other wireless communication. The digital control module may also be in electronic connection with pressure sensors located at or near the periphery of the alternating pressure garment proximal to the surface of the animal.

Generally, some of the most successful outcomes related to canine anxiety reduction are borne out with intervention by a behaviorist veterinarian. In this method, thoughtful and extensive training coupled with various de-sensitizing techniques are associated with the actual, real-time triggers for the anxiety to achieve positive results. However, certain real-time stimuli such as thunder or fireworks make treatment difficult or impossible using this method. In addition, with only about 100 certified behaviorist veterinarians out of some 60,000 total veterinarians in the US, anxiety treatment via this approach is out of reach for most.

Another method of reducing anxiety in animals utilizes physical contact as a means of producing large area lateral pressure between animals and was originally reported for cattle in squeeze chutes. Constant pressure garments purported to reduce anxiety in dogs are commercially available with one study focused on separation anxiety indicating a reduced heart rate. Another study reported the use of these constant pressure vests do have a calming effect as reported by the dog owners, but the results statistically reflected no greater benefit than that of a placebo.

One challenge associated with constant pressure garments is the well-known phenomenon of sensory adaptation. Sensory adaptation is an animal's response to the presence of a constant stimulus acting on one or more of the senses. A common, familiar manifestation of sensory adaptation is when new odors are initially strongly registered by the brain. But after a relatively short time, the odor receptors experience sensory fatigue, or olfactory adaptation, and the odor no longer registers. The sense of touch is also susceptible to sensory adaptation as anyone wearing clothes, a hat, a wrist watch or alike can attest; you lose the sensation of the these objects minutes or seconds after wearing them.

The digitally controlled alternating pressure garment described herein addresses multiple shortcomings of historical and current approaches for animal anxiety reduction. Utilizing the monitoring of the real-time environment, activity, or physiological parameters of the animal to detect common triggers for anxiety, the digitally controlled alternating pressure garment may induce a physical change to a wearable garment before, at the onset of, and during the anxiety causing events. The alternating pressure garment makes use of a digital control module with monitoring sensors which then can initiate inflation of air bladders incorporated into a garment once appropriate digital signals are detected. The inflated bladders then provide a real-time pressure sensation to the wearer of the garment which is an improvement relative to constant pressure garments. In addition, the inflated bladders can be further controlled in a number of ways including deflation after a sensor-detected period of reduced anxiety, cycling inflation and deflation periods to ensure sensory adaptation does not occur, and other modalities. In addition, different individual bladders or subsets of bladders can be inflated and/or deflated in any combination which ensures a changing body surface pressure location experience for the canine thereby avoiding sensory adaptation. Furthermore, additional means of controlling the device can involve communication with the digital control module via WiFi, Bluetooth, cellular or other communication protocols using a specific application designed for the device. Yet another method of controlling the device involves communication with any number of currently available digital monitoring devices for animals.

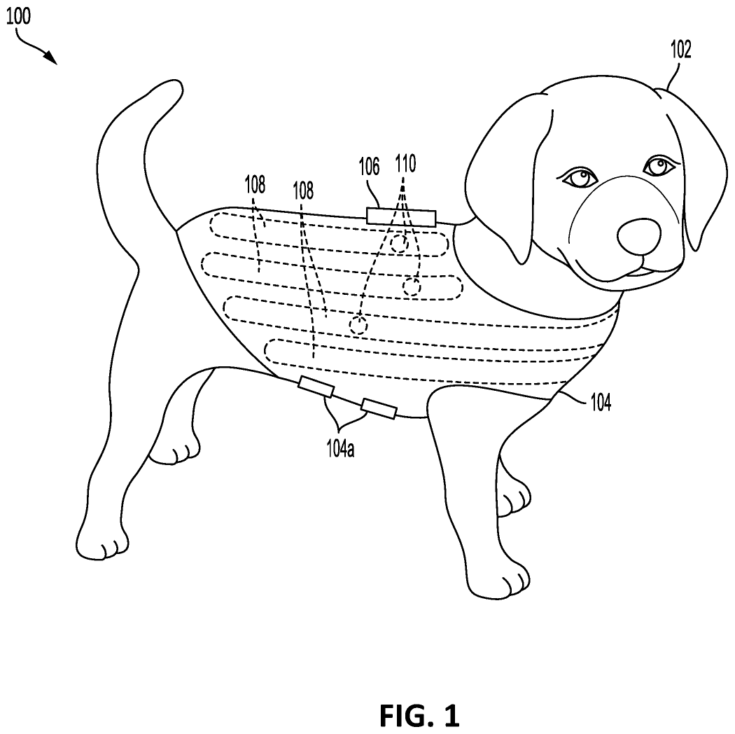

Referring to FIG. 1, an example of a digitally controlled alternating pressure garment 100 being worn by a canine 102 is shown. The canine 102 is an example of a companion animal. While the example subject of FIG. 1 is depicted as the canine 102, the digitally controlled alternating pressure garment 100 may be used on other companion animals, farm animals, pets, etc. The digitally controlled pressure garment (alternating pressure garment) 100 includes a fabric or polymeric shell 104, one or more clasping devices 104a, a pressurizing module 106, a plurality of inflatable bladders 108, and a plurality of optional pressure sensors 110. As used herein, the fabric shell 104 may include other materials such as polymeric materials configured to be worn by the canine 102. The fabric shell 104 is configured to fit around the body of the canine 102 (e.g., forechest/shoulder area and extend lengthwise towards the croup as depicted in FIG. 1). When the one or more clasping devices 104a are coupled, the fabric shell 104 may be configured to fit snuggly around the girth (e.g., brisket) of the canine. The pressurizing module 106 may be disposed on an outer surface of the fabric shell 104 and is in fluid communication with the plurality of bladders 108. The plurality of bladders 108 are disposed on an inside surface of the fabric shell 104 and are configured to increase the pressure on the canine 102 when inflated. Furthermore, the plurality of the bladders 108 can be alternately deflated and re-inflated to ensure sensory adaptation does not occur. In an example, each of the plurality of bladders 108 extends lengthwise along the canine's body and may be constructed of a flexible material to enable the canine 102 to maintain a full or near-full range of motion. That is, the bladders 108 can experience alternating inflation and deflation thereby changing the pressure experienced on the canine's body, and the configuration (e.g., dimensions and flexibility) of the bladders 108 will not immobilize the canine 102. The plurality of bladders 108 may be fluidly connected to one or more optional manifold assemblies, bleed values and pressure sensors (not shown in FIG. 1). The optional bleed values and pressure sensors may be operably connected to the pressurizing module 106. In operation, the pressurizing module 106 is configured to inflate or deflate one or more of the plurality of bladders 108 to a desired pressure. The optional pressure sensors 110 may be operably coupled to the pressurizing module 106 and are configured to measure the alternating pressure being exerted by the alternating pressure garment 100.

In an example, the alternating pressure garment 100 is a single or multi-layered fabric or polymeric garment with affixing hook and loop features as the clasping 104a, the pressurizing module 106 including a digital control module. The alternating pressure garment 100 may contain an embedded single air bladder or a plurality of embedded air bladders 108 which are in fluid connection to the pressurizing module 106. The pressurizing module 106 may function in either a positive pressure generation mode or a negative pressure mode (e.g., vacuum assisted or bleed-off loss of positive pressure). There may contain a manifold between the pressurizing module 106 and the air bladders 108. The manifold can be configured to direct air flow to and from combinations of the air bladders 108. Inflation of the air bladders may controlled by the digital control module in the pressurizing module 106. The digital control module may include one or more sensors for monitoring the activity, the environment, or various other physiological states of the canine 102. The alternating pressure garment 100 may optionally have a single or plurality of pressure sensors incorporated within the fluidic air bladder system or incorporated between the air bladders and the garment layer proximal to the surface of the canine 102.

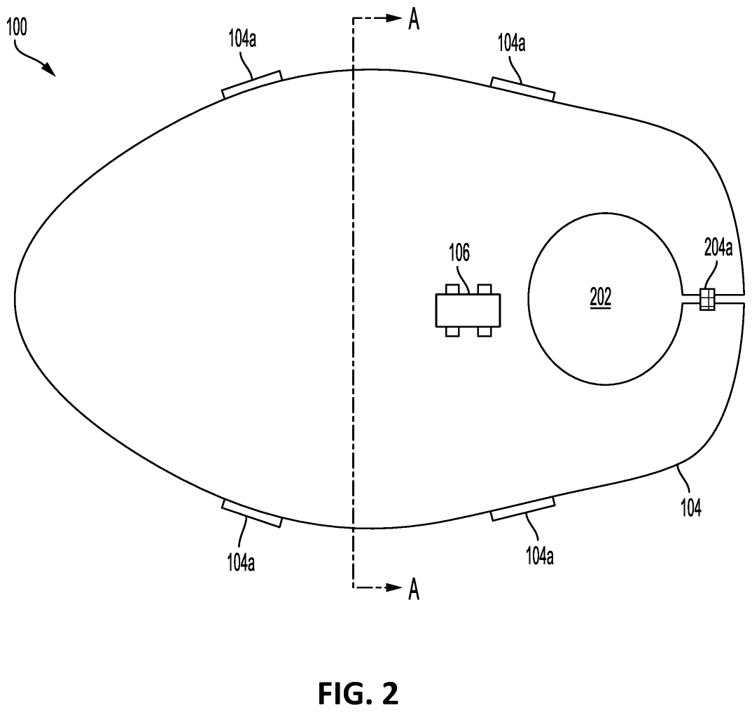

Referring to FIG. 2, with further reference to FIG. 1, a top view of the example digitally controlled alternating pressure garment 100 is shown. The alternating pressure garment 100 includes a fabric or polymeric shell 104, the clasping devices 104a, and the pressurizing module 106. An open area 202 in the alternating pressure garment 100 is configured to accommodate the neck area of the canine 102. In an embodiment, the alternating pressure garment 100 may include one or more foreclasps 204a configured to be disconnected to allow the alternating pressure garment 100 to be placed around the canine's neck area, and then reconnected once the garment is around the canine's neck. The clasping devices 104a and the foreclasps 204a may be one or more of known fastening devices including, but not limited to, hook and loop, zipper(s), buttons, snaps, buckles, ties and other devices configured to secure two materials. The clasping devices 104a may be at discrete locations along the edges of the fabric shell 104 (e.g., buckles) or continuous along the edges (e.g., zipper, hook and loop). In an example, the alternating pressure garment 100 may be configured to slip over the head of the canine like a sweater without the use of clasping devices (e.g., a tubular shape with ports to accommodate the head and forelegs). The fabric or polymeric shell 104 may include synthetic and natural materials such as, but not limited to, nylon, canvas, wool, polyester, elastic, bamboo, cotton, combinations of layered materials, laminated materials, or other flexible materials configured to enable a compressive force around the canine 102 without severely limiting the mobility (e.g., lateral motions) of the canine 102. The pressurizing module 106 may be affixed to the fabric or polymeric shell 104 via stitching (e.g., sewing), fasteners, adhesive, welds, or disposed in a pocket within the fabric shell 104.

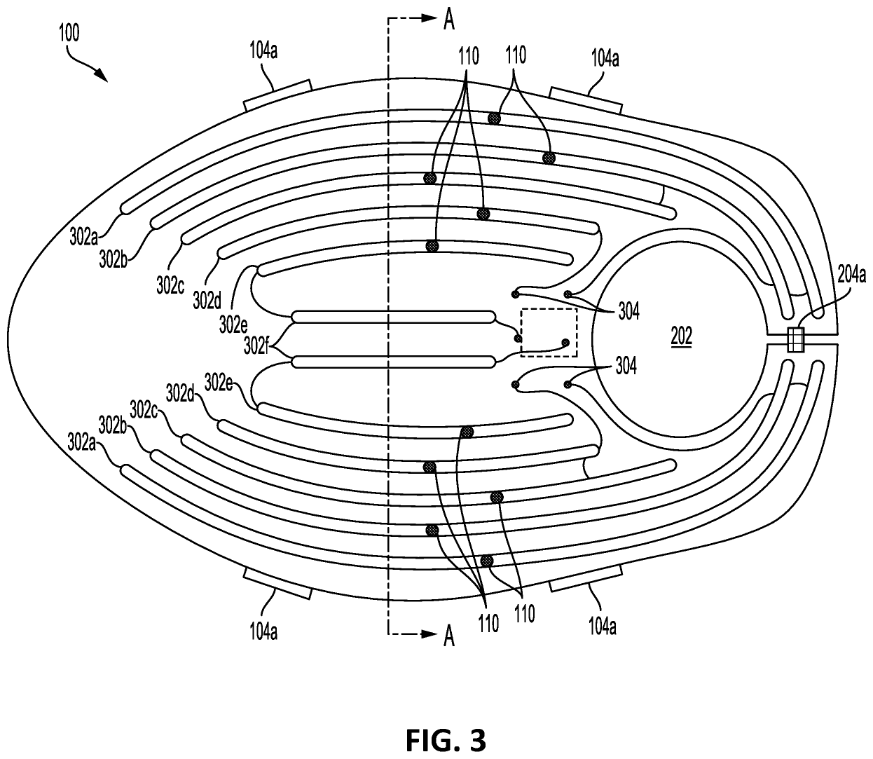

Referring to FIG. 3, with further reference to FIGS. 1 and 2, a bottom view of the example digitally controlled alternating pressure garment 100 is shown. In an example, the inside of the fabric or polymeric shell 104 includes a plurality of bladders 302a-f running longitudinally along the length of the alternating pressure garment 100. The number, sizes and locations of the bladders 302a-f are exemplary only and not a limitation as other form factors and orientations for the bladders 302a-f may be used. For example, a plurality of smaller bladders may be used to create alternating pressure while minimizing the impact on the mobility of the canine 102. The locations of the bladders 302a-f may be configured to accommodate large nerve areas and other sensitive regions on the canine 102. The dimensions, locations and number of bladders 302a-f may vary based on the size, breed and other characteristics of the canine 102 and to avoid sensory adaptation. In an example, the bladders 302a-f may be formed in a multi-layer structure inside of the fabric or polymeric shell 104. The multi-layer structure may be formed from joining discrete layers together to form the material stack or from coated, laminated or otherwise fused materials. For example, the inner most layer comprising the functional bladder may be made from 1.0-30.0 mil thick thermoplastic polyurethane (TPU) or polyvinyl chloride (PVC) film which has been welded to form the bladders 302a-f The bladders 302a-f typically contain connectors for establishing fluid connection with the pressurizing module 106 via tubing and/or manifolds 304. The inner TPU or PVC bladders may be covered on both sides by a laminate structure that provides multiple performance requirements for the canine 102 including comfort for the wearer, allowing lateral movement, protection of the air bladder from potential puncture, and transference of therapeutic alternating pressure from the air bladders to the canine's 102 external surface. This laminate structure may incorporate multiple materials of varying thicknesses to simultaneously satisfy these requirements. For example, there may be a cushioning foam layer between 40-500 mil thick surrounding or encapsulating the outside of the air bladder which is in turn surrounded or encapsulated by a garment-like comfort layer between 1.5-250 mil thick. The bladders 302a-f may also be constructed of materials which have already been made into a multi-layer, fused laminate structure (i.e., a TPU or PVC air bladder layer coated or laminated with another material). Other materials may also be used to form the bladders 302a-f.

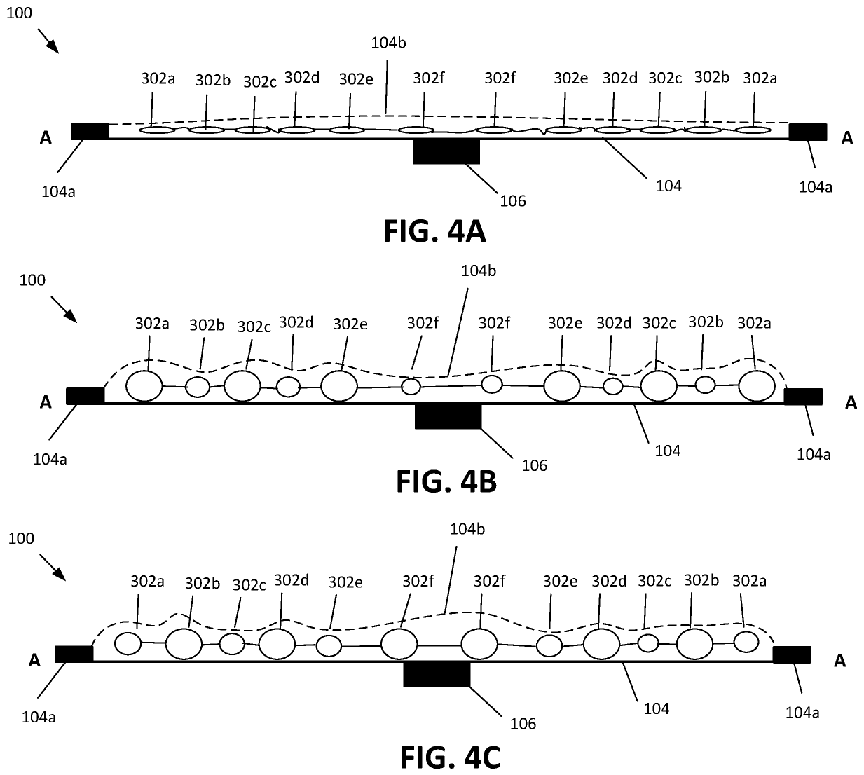

Referring to FIGS. 4A, 4B and 4C with further references to FIGS. 1-3, cross-section views of an example digitally controlled alternating pressure garment 100 in a deflated state and an inflated state are shown. FIGS. 4A, 4B and 4C represent the cross-section along plane ‘A’ indicated on FIGS. 2 and 3. The plurality of bladders 302a-f are disposed inside of the fabric or polymeric shell 104 and may be incorporated within or disposed underneath an optional inner lining 104b. The inner lining 104b may be a synthetic or natural material configured to be in contact with the exterior of the canine 102 (e.g., the coat/fur). In an embodiment, the inner lining 104b may be removable to facilitate cleaning and/or replacement. For example, the inner lining 104b may be detachable connected to the clasps 104a, the bladders 302a-f, and/or the fabric shell 104. In an example, the fabric or polymeric shell 104, the bladders 302a-f, and the inner lining 104b may be a single laminate structure. In another example, the bladders 302a-f can be configured as separate components which can be added or attached to the fabric or polymeric shell 104 and connected operably to the pressurizing module 106. FIG. 4A illustrates the bladders in a deflated state (e.g., less than 0.2 psi). The pressurizing module 106 is operably connected to the plurality of bladders 302a-f and optionally to one or more bleed valves and pressure sensors (not shown in FIG. 4A), and is configured to reduce the pressure in the bladders 302a-f by allowing the air to evacuate from the bladders. In an example, the pressurizing module 106 may be configured to exert negative pressure on the bladders 302a-f to evacuate the air.

FIG. 4B illustrates the bladders 302a-f with a first group of bladders 302a, 302c 302e expanded when in an inflated state (e.g., more than 0.2 psi). A second group of bladders 302b, 302d, 302f are in a less than inflated state (e.g., less pressure than the first group of bladders 302a, 302c 302e). FIG. 4C illustrates the bladders 302a-f with the second group of bladders 302b, 302d, 302f in an inflated state, and the first group of bladders 302a, 302c 302e in a less than inflated state. The dimensions and disposition of the bladders 302a-f are examples only as other bladder configurations may be used. The dimensions and disposition of the bladders 302a-f may vary based on the size and/or breed of the canine 102 or the optimal alternating pressure application to avoid sensory adaptation. For example, the diameter of the inflated bladders 302a-f may be in the range of 0.5-1.5 inches for larger canines, and in a range of 0.15-1.0 inches for smaller breeds. Other configurations may be used on other domestic animals (e.g., cows, goats, sheep, horses, etc.). The pressure of the inflated bladders 302a-f may be in the range of 0.2-14.0 psi. In operation, the pressure value may be based on the material composition of the bladders 302a-f. More flexible bladder materials may be inflated to a higher pressure without excessively limiting the mobility of the canine. The combination of the bladder material and inflated pressure value may be selected to provide an inward alternating pressure while allowing lateral movement of the canine's chest and abdomen areas.

The pressurizing module 106 and one or more optional manifolds (not shown) are configured to inflate one or more bladders, such as the first group of bladders and the second group of bladders, in alternating zones to achieve alternating pressure at the surface in contact with the canine 102 which facilitates the avoidance of sensory adaptation. Furthermore, the alternating zones of pressurization for the bladders 302a-f can be readily changed through the pressurizing module 106. For example, as depicted in FIGS. 4B and 4C, the pressurizing module 106 may be configured to alternately inflate and deflate the first group of bladders 302a, 302c 302e and the second group of bladders 302b, 302d, 302f The period between inflation and deflation cycles for each group need not be equal and regular (i.e., both groups may be in an inflated state or deflated state at the same time). In another example, the pressurizing module 106 can initially inflate only bladders 302a-b leaving bladders 302c-f deflated for a period of time and subsequently inflate only bladders 302c-f while deflating bladders 302a-b. Other combinations of inflation and deflation for the bladders 302a-f may be achieved through the pressurizing module 106 and configuration options for manifold(s) and fluidic connections to the bladders 302a-f (not shown).

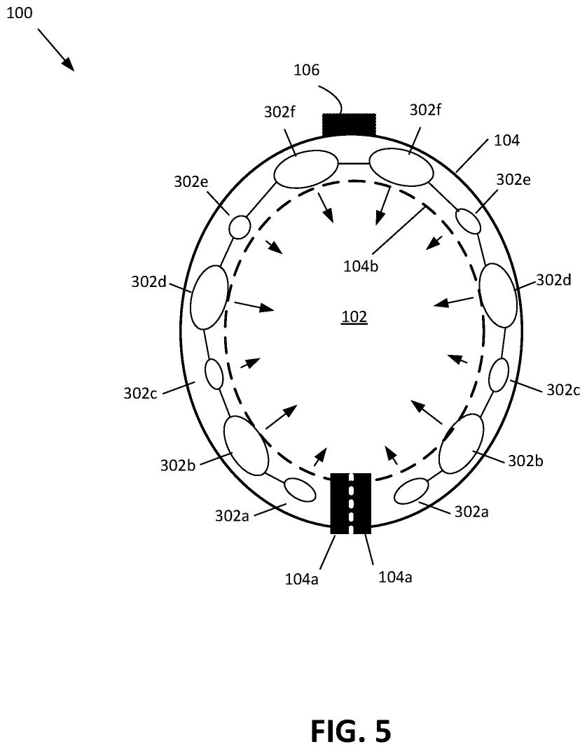

Referring to FIG. 5, with further reference to FIGS. 1-4C, a cross-section view of an example digitally controlled alternating pressure garment 100 disposed on a canine 102 is shown. The alternating pressure garment 100 is wrapped around the girth of the canine 102 and the clasping devices 104a are secured to one another. In combination, the fabric or polymeric shell 104 and the clasping devices 104a provide a resistive force to enable the bladders 302a-f to create an alternating pressurizing force towards the canine 102. The flexibility of the bladders 302a-f and the fabric or polymeric shell enable the application of an alternating pressurizing force as depicted in FIG. 5 without immobilizing the canine 102. In an example, the inflated diameter of bladders 302a-f is substantially less than the length of bladders 302a-f (e.g., ratios of 1/4, 1/5, 1/6, 1/7, 1/10, and lower). The bladders 302a-f depicted in FIGS. 1-5 are examples only as other bladder designs may be used to enable flexibility while exerting an alternating pressurizing force. For example, multiple small bladders with fabric between each bladder (e.g., chained together) will enable a flexible alternating pressure garment. In an example, the inner liner 104b may have one or more areas of an increased stiffness to spread the area of contact with the canine 102 and equalize the pressure over the one or more areas. For example, the area of the inner liner 104b proximate to the abdomen area (e.g., stomach, intestines) may be thicker and relatively less pliant to spread the alternating pressure force created by the bladders 302a-f more equally over the abdomen area as compared to just the bladders 302a-f alone. While FIG. 5 depicts some bladders in an inflated state (e.g., 302b, 302d, 3020 and some bladders in a deflated state (e.g., 302a, 302c, 302e), the alternating pressure garment 100 is not so limited. In an example, each of the bladders 302a-e may be in various states of inflation or deflation independently or concurrently with other bladders 302a-e.

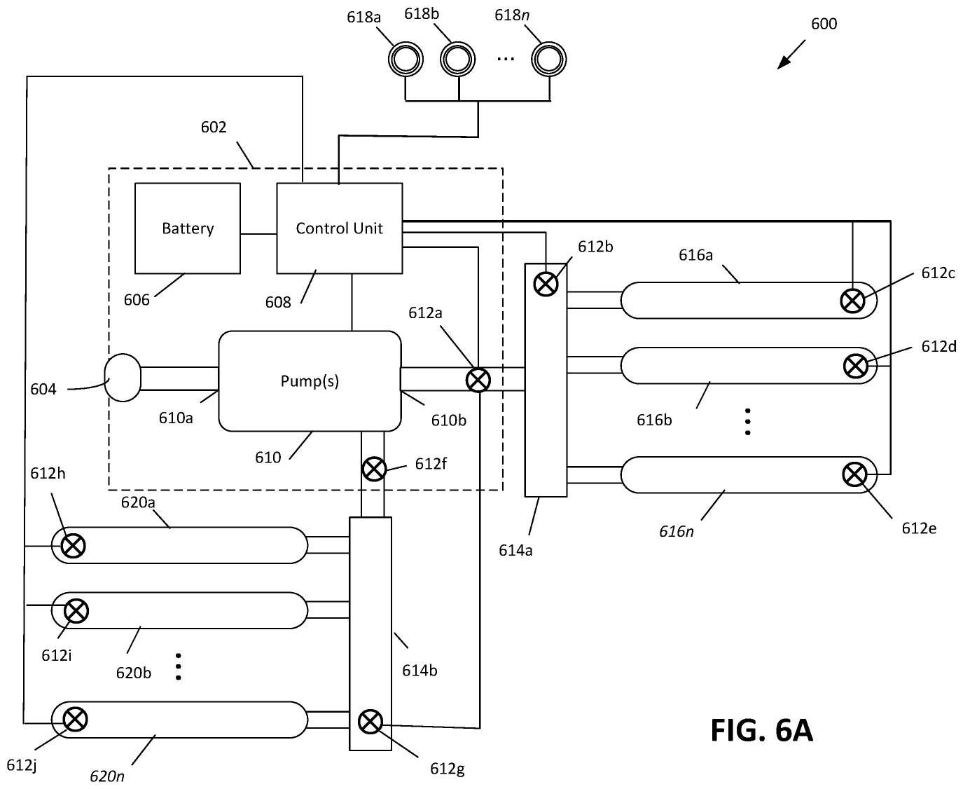

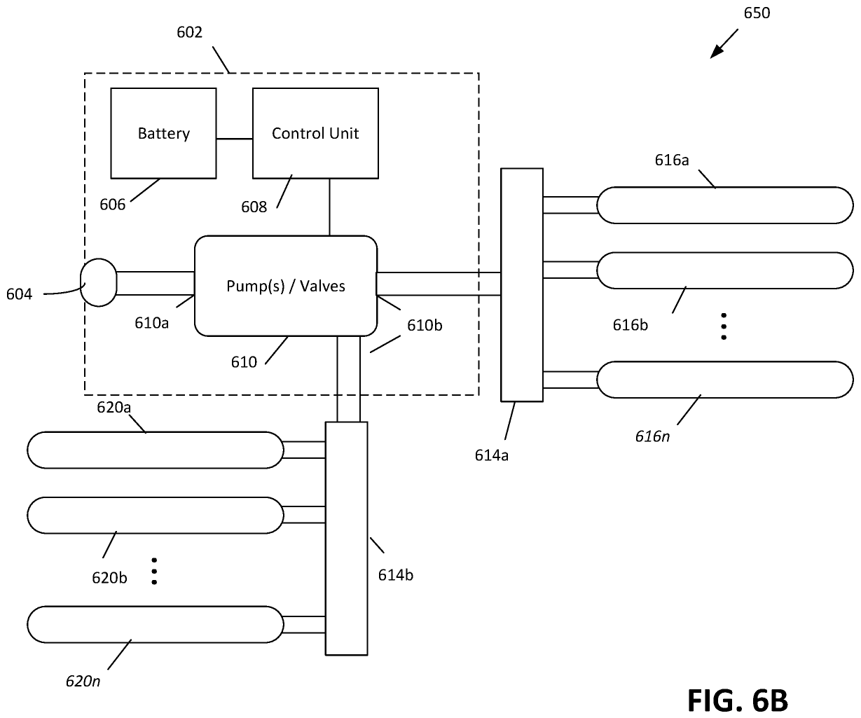

Referring to FIG. 6A a system diagram of an example digitally controlled pressure distribution system 600 with optional pressure sensors is shown. The distribution system 600 includes the pressurizing module 106 and bladders 302a-f described in FIGS. 1-5. The flexible shell 104 is not depicted in FIG. 6A in an effort to simplify the description. The distribution system 600 includes a pressurizing module 602, at least one manifold 614a operably coupled to a plurality of bladders 616a-n. In an embodiment, the distribution system 600 may include one or more additional manifolds 614b operably coupled to a second plurality of bladders 620a-n. The bladders 616a-n, 620a-n are examples of the bladders 302a-f in FIG. 3. While the distribution system 600 depicts two manifolds 614a-b, embodiments may include additional manifolds with each manifold being operably coupled to another one or more of bladders. The pressurizing module 602 includes a battery 606, a control unit 608 operably coupled to one or more pumps 610. Each of the pumps 610 includes an intake 610a and an output 610b. The output 610b is fluidly connected to the bladders 616a-n via the manifold 614b. In an example, the distribution system 600 may include one or more optional pressure sensors 612a-j operably coupled to the control unit 608 and configured to measure the air pressure at one or more points within the distribution system 600. For example, a first set of optional pressure sensor 612a may be disposed proximate to the pump output 610b. A second set of optional pressure sensors 612b, 612g may be disposed on the manifolds 614a-b, and each of the bladders 616a-n, 620a-n may include a pressure sensor 612c-e, 612h-j. In an embodiment, one or more of the pressure sensors 612a-j may be bleed valves operably coupled to the control unit 608 and configured to release pressure in the distribution system 600. FIG. 6A depicts the manifolds 614a-b fluidly connected to the pumps 610 but the distribution system 600 is not so limited as various combinations of pumps and manifold assemblies may be used. For example, a single pump may be coupled to more than one manifold or more than one pump may be coupled to a single manifold.

A plurality of optional pressure sensors 618a-n may be disposed between the canine 102 and the alternating pressure garment 100 and operably coupled to the control unit 608. The optional pressure sensors 618a-n are configured to measure the alternating pressure force that is exerted by the alternating pressure garment 100 as the bladders 616a-n, 620a-n are inflated. The optional pressure sensors 618a-n may be piezoresistive devices integrated (e.g., sewn, welded, fastened, or otherwise attached) to one or more of the bladders 302a-f, inner lining 104b, or the fabric shell 104. In an example, the optional pressure sensors 618a-n may be disposed between the bladders 302a-f and the fabric or polymeric shell 104. The control unit 608 may be configured to utilize signals generated by the optional pressure sensors 618a-n as feedback to control the operation of the pumps 610.

In operation, the distribution system 600 within the alternating pressure garment 100 is configured to provide localized pressure to the body surface of the canine 102 and thereby provide anxiety reduction therapy. Alternating pressurization is initiated via the control unit 608 when appropriate signals from pressure sensors 612a-j, timing circuits, external sensors in communication with the digital control unit, or other external communication means are received by the control unit 608. Once appropriate signal(s) are determined by the control unit 608, the one or more pumps 610 are actuated to produce positive pressure flowing into bladders 616a-n, 620a-n. One or more manifolds 614a-b may be disposed between the one or more pumps 610 and the bladders 616a-n, 620a-n. Inflation of any of the bladders 616a-n, 620a-n may be adjusted (e.g., increased, decreased, initiated, halted) based on one or more optional means. For example, the inflation may be directed to a subset of bladders 616a-n and adjusted based on a predetermined pump duration cycle stored in a memory the control unit 608. The inflation may be adjusted based on a detected change in one or more of anxiety-inducing triggers (e.g., physiological state such as heart rate). The inflation may be adjusted based on one or more commands received via wireless communications with the control unit 608. The inflation may be adjusted based on signals received from one or more of the optional pressure sensors 618a-n, the optional pressure sensors 612a-j associated with the pump output 610b, the manifolds 614a-b, and the bladders 616a-n, 620a-n. In an example, the optional pressure sensors 618a-n may be integrated within the alternating pressure garment 100 between the bladders 616a-n, 620a-n and the outer surface of the canine 102 animal as shown in FIGS. 1 and 3. The optional pressure sensors 618a-n and/or the optional pressure sensors 612a-j may be integrated directly within the air bladder system in fluidic communication with the bladders themselves or via a manifolds 614a-b in fluid communication with the pump and bladders 616a-n, 620a-n. In an embodiment, the distribution system may have one of the optional pressure sensors 618a-n or the optional pressure sensors 612a-j, and the control unit 608 may be configured to control the pumps 610 based on the signals received from either the pressure sensors 618a-n or the optional pressure sensors 612a-j.

In an example, the control unit 608 may include an Internet of Things (IoT) chipset (e.g., Qualcomm MDM9207 IoT Modem) including a radio transceiver configured to send and receive information over a wireless communication protocol such as 3G/4G LTE/5G, WiFi and Bluetooth. The IoT chipset may include GNSS navigation capabilities. The control unit 608 may be paired with a mobile device such as a smartphone, a tablet, a computer, or other network enabled device, and the control unit 608 may be configured to receive and store timing information received from the mobile device. For example, the control unit 608 is configured to inflate combinations of the bladders 616a-n, 620a-n with positive pressure for a variable amount of time period based on one or more parameters or algorithms. The control unit 608 may also be configured to deflate any combination of the bladders 616a-n, 620a-n based on parameters for the same optional means described for inflation (i.e., pump duration cycle, detection of anxiety reducing parameters, optimized therapeutic cycling to avoid sensory adaptation, wireless commands or routines, pressure sensors). Once an appropriate control signal(s) are generated by the control unit 608, multiple methods of achieving inflation and deflation are possible. In an example, deflation may occur passively via air bleed off valves integrated within the distribution system 600 (e.g., the optional pressure sensors 612a-j may be configured as bleed off valves) or via inherent loss of pressure within the fluidic system (e.g., without presence of air bleed off valves). Deflation of the bladders 616a-n, 620a-n may occur actively by activating negative pressure or a vacuum pump. The pumps 610 may include both vacuum pumps and positive pressure pumps (i.e., used for inflation), or dual function pumps (i.e., pump systems capable of performing both positive and negative pressure modes).

Referring to FIG. 6B, with further reference to FIG. 6A, a system diagram of an example digitally controlled pressure distribution system 650 is shown. The distribution system 650 includes the pressurizing module 106 and bladders 302a-f described in FIGS. 1-5. The distribution system 650 includes a pressurizing module 602, an optional manifold 614a operably coupled to a plurality of bladders 616a-n. In an embodiment, the distribution system 650 may include one or more additional manifolds 614b operably coupled to a second plurality of bladders 620a-n. While the distribution system 650 depicts two manifolds 614a-b, embodiments may include additional manifolds with each manifold being operably coupled to another one or more of bladders. In an example, the manifolds 614a-b are not required and the bladders 616a-n and 620a-n may be connected to the pump output(s) 610b. For example, the distribution system 650 may include a plurality of pumps 610, with each pump 610 fluidly connected to one or more of the bladders 616a-n or the bladders 620a-n. An alternating pressure may be realized by alternatively activating each pump 610 to increase the pressure in the bladders that are connected to that pump. In an example, one pump may be operated in a positive pressure mode to inflate the connected bladders while another pump is operated in a negative pressure mode to deflate the connected bladders. In another example, one pump may be operated in a positive pressure mode to inflate the connected bladders while another pump is left idle to allow the connected bladders to deflate via pressure leakage through the idle pump. In an example, each of the bladders 616a-n, 620a-n, and/or the optional manifolds 614a-b may also include a bleed orifice that will allow air to escape from the bladders at a flow rate that is less than the flow rate of input air with the pump is in a positive pressure mode. Thus, the alternating pressure garment may be realized by changing pump states such as activating pumps in a positive pressure mode at different times, and then allowing the pressure in the bladders to reduce when the pumps are in an idle state.

In an embodiment, the pump(s) 610 may include one or more valves configured to enable the a pump to provide positive pressure to the bladders 616a-n, 620a-n. The valves may be operably coupled to the control unit 608 and configured to react based on signals received from the control unit 608. For example, a single pump with a two-way valve may be used to provide positive or negative pressure to either the first set of bladders 616a-n or the second set of bladders 620a-n. In this example, the control unit 608 may be configured to activate a pump and activate the valve in a first position to provide pressure to the first set of bladders 616a-n, or activate the valve in a second position to provide positive pressure to second set of bladders 620a-n. Other numbers and combinations of pumps and valves may be controlled by the control unit 608 to align a pump with one or more bladders.

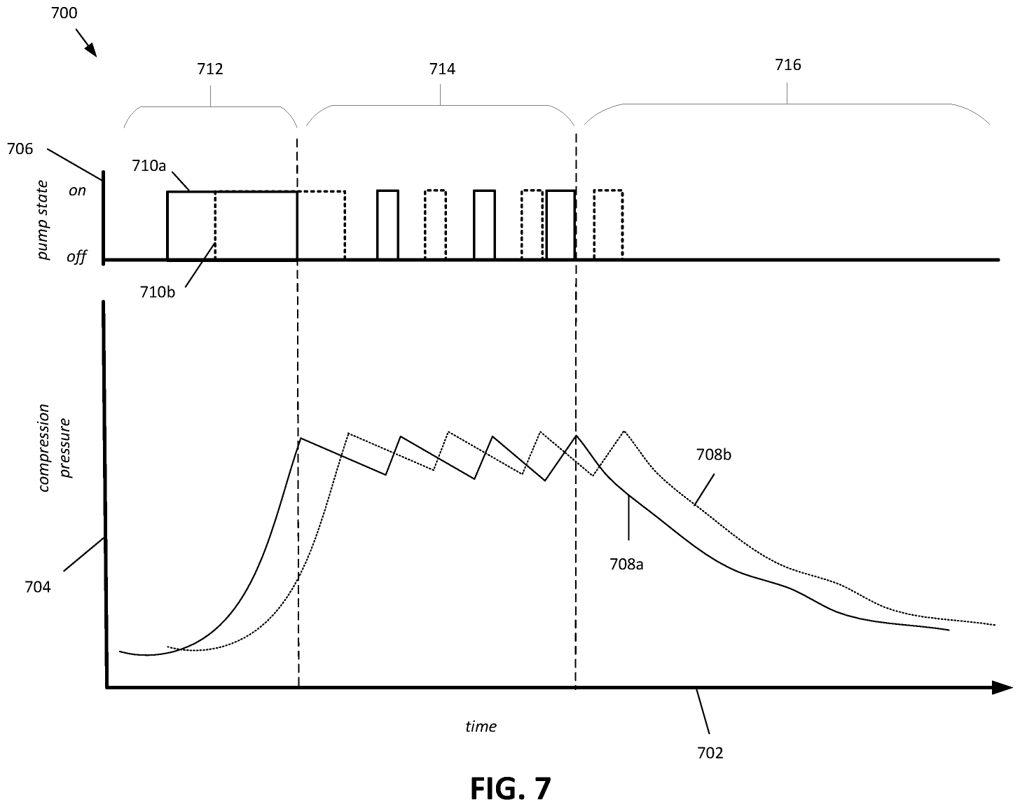

Referring to FIG. 7 an example electronic timing diagram 700 of pump states and alternating pressure functions is shown. The diagram 700 is exemplary only and not a limitation. In general, the control unit 608 includes one or more memory and processing units configured to control the pumps 610 based on the example timing diagram 700. The diagram 700 includes a time axis 702, an alternating pressure axis 704, a pump state axis 706, one or more pressure functions 708a-b, and one or more pump states 710a-b. The timing diagram 700 is an example use case for the digitally controlled alternating pressure garment and includes three example zones 712, 714, 716. In an inflation zone 712, the pump state 710a is on (i.e., the pump(s) 610 are activated) causing the pressure function 708a to increase. While the pump state 710a is depicted as binary (i.e., on/off), other variable pumps states such as voltage and pump rate may be used and the rate of increase in the pressure function 708a may be varied. In an example, the pressure function 708a may correspond to the first group of bladders 302a, 302c, 302e. In an alternating pressure zone 714, the pump state 710a may oscillate periodically (e.g., 1, 0.5, 0.1, 0.01 Hz) to cause alternating pressure function 708a to vary between two or more setpoints. The set points may vary between 0 and any fraction of the maximum pressure (e.g., 1, 2, 4, 6, 8, 12, 14 psi, etc.). The oscillation in the pressure function 708a corresponds to an oscillation in the alternating pressure garment and thus varies the pressure stimulus on the canine 102. In an embodiment, the pumps 610 may be controlled by the pump state 710b creating the pressure function 708b. The pressure function 708b may correspond to the pressure in the second group of bladders 302b, 302d, 302f While the pump states 710a-b and pressure functions 708a-b are shown in a leading/lagging configuration, the pumping states are not so limited. Various combinations of pump states 710a-b and the resulting pressure functions 708a-b may be used to generate alternating pressure on the canine 102. In an embodiment, all bladders 302a-f may be inflated and deflated simultaneously based on a single pressure function 708a. The variation in pressure stimulus provides an advantage in overcoming sensory adaptation issues associated with prior solutions. The oscillations in the alternating pressure zone 714 are examples only, and not a limitation, as the alternating pressure zone may be a constant value or may have differing high-low set points with different periods. Furthermore, a set of oscillations in the alternating pressure zone 714 can be solely derived for and associated with a subset of the bladders 302a-f while an entirely different set of oscillations can be associated with another subset of the bladders 302a-f. The set-point pressures and timing may be random or previously determined (e.g., not periodic). For example, the control unit 608 may include a data structure (e.g., look-up table) with the pressure set-points and timing information. The oscillations in the alternating pressure zone 714 may be based on the current physiological inputs of the canine 102. For example, if the canine 102 is in an agitated state (e.g., increased motion, barking/whining, increased heart rate), the upper and lower pressure set-points may be higher and the oscillation rate increased as compared to when the canine 102 is in a relaxed state. Certain combinations of pressure set-points and the associated timing information may be more effective on individual canines or to avoid sensory adaptation. The pressure set-points for a bladder configuration may be based solely on pump activation times (i.e., open loop) without the need for feedback from a pressure sensor. That is, a bladder may achieve a pressure set-point based on activating the pump for a fixed amount of time. The control unit 608, or other networked resource, may be configured to correlate alternating pressure function with the physiological inputs to determine optimal control solutions. As will be described, alternating pressure functions may be crowdsourced to network resources to enhance the effectiveness of the alternating pressure garment across an installation base.

In operation, the increases and decreases in pressure may be realized with pumps 610 providing positive and negative pressure. In an example, the pumps 610 may provide positive pressure and one or more optional orifice holes and/or bleed valves on the bladders 302a-f may allow the pressure to decrease. Loses flowing back through an idle pump, or a pump operating in negative pressure mode, may also allow the pressure in the bladder 302a-f to decrease. In an example, the values on the pressure functions 708a-b may be based on signals from one or more of the optional pressure sensors 618a-n and/or the pressure sensors 612a-j. A deflate zone 716 represents a period of deflating the bladders 302a-f to zero, or some nominal value. The rate of the pressure functions 708a-b in the deflate zone 716 is an example only and may be based on the physiological state of the canine 102. For example, if the canine 102 becomes agitated during the deflate zone 716, then the control unit 608 may be configured to transition at any point to the inflation zone 712 and the alternating pressure zone 714.

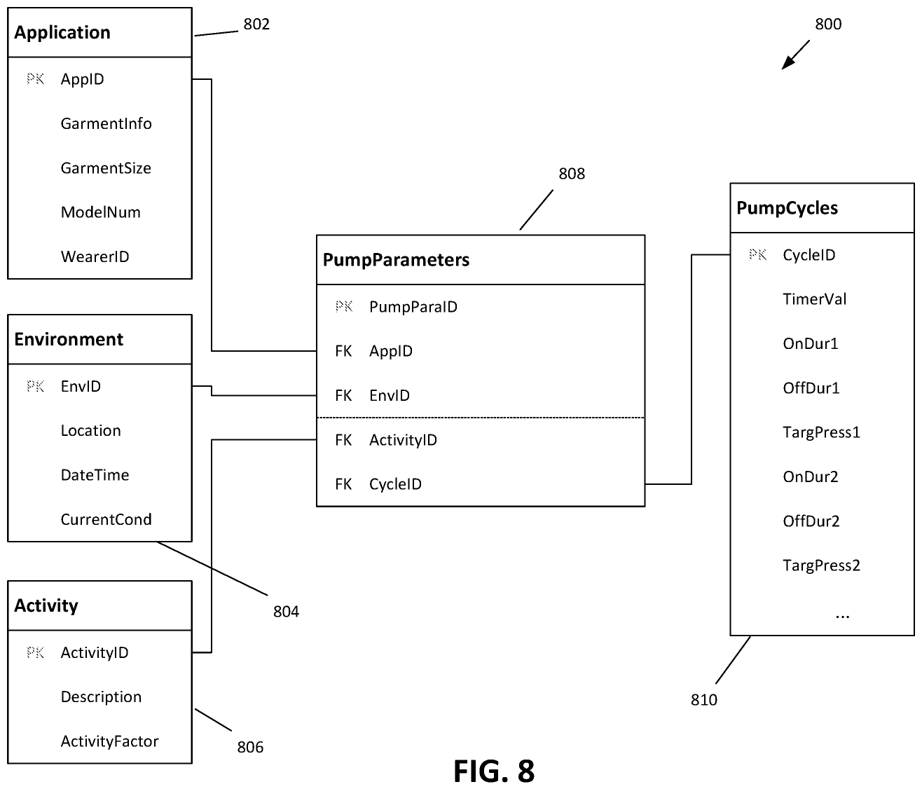

Referring to FIG. 8, with further reference to FIG. 7, an example data structure 800 for setting alternating pressure garment pump timing parameters is shown. The data structure 800 may be stored in one or more files such as XML, JSON, CSV or other data format. The classes and attributes depicted in FIG. 8 are examples only, and not limitations, as other classes and attributes may be used. An applications class 802 may include a primary key (AppID) and additional fields to categorized a digitally controlled alternating pressure garment. Attributes may include information about the model and configuration of a particular alternating pressure garment (e.g., animal type, model number, bladder configuration), as well as the size of the garment (e.g., large, medium small). Information about the specific user (i.e., wearer) of the alternating pressure garment (e.g., unique ID value) may be stored. Other application attributes may also be included in the application class 802.

An environment class 804 may include a primary key value (EnvID) as well as attributes to describe where and when the alternating pressure garment is being used. For example, a location attribute, a DateTime attribute and a Current Conditions attribute may be included in the environment class 804. Other environment related information may also be stored as attributes in the environment class 804.

An activity class 806 may include a primary key (ActivityID) as well as attributes to indicate the current context of the digitally controlled dispersal system. For example, a description attribute may be associated with an activity level (e.g., low, medium, high), or other state such as wet or dry. An activity factor attribute may be used as a relative reference between activity states. The activity factors may indicate the physiological state of the alternating pressure garment wearer (e.g., motion, sound level, heart rate, etc.).

A pump cycles class 810 includes a primary key (CycleID) and a plurality of attributes configured to generate pump timing parameters such as depicted in FIG. 7. For example, the attributes may include a plurality of pump-on and pump-off values and timing values. The on-off states may include voltage or other settings to control variable pumps. The states may also indicate positive and negative pressure modes. In an embodiment, the pump states may include optional bleed valve states (e.g., open, close) for one or more bleed vales in a pressure distribution system. The variables for controlling the alternating pressure zone 714 may be included in the pump cycles class 810.

A pump parameters class 808 includes a primary key value (PumpParaID) and a foreign keys associated with the application class 802, the environment class 804, the activity class 806, and the pump cycles 810. The foreign key values may be null to indicate that not every class is required to correlate the pump timing parameters with at least one class attribute.

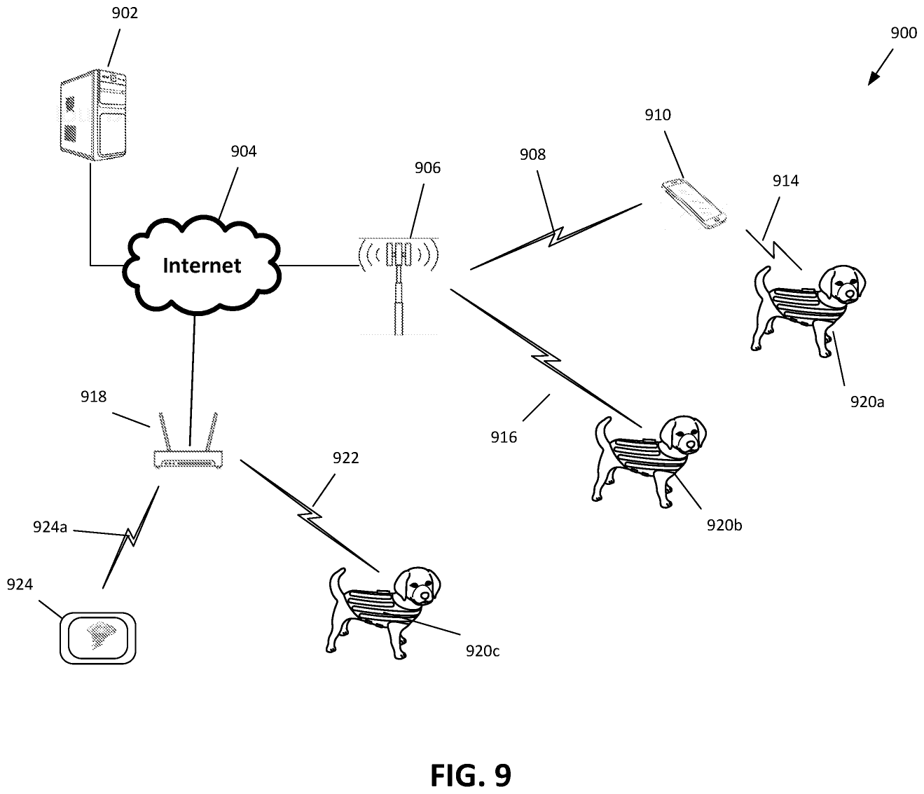

Referring to FIG. 9, with further reference to FIGS. 1-8, a system architecture diagram of an example network 900 to receive and distribute control variables for one or more digitally controlled alternating pressure garments. The network 900 depicts a plurality of digitally controlled alternating pressure garments 920a-c and associated canines. The alternating pressure garments 920a-c are examples of alternating pressure garment 100 previously described. Each of the alternating pressure garments 920a-c are configured to communicate with a server 902 via the Internet 904. In an example, the Internet 904 may be accessed via a mobile network (e.g., 3G, LTE, 5G, etc.). The network 900 includes a first alternating pressure garment 920a, a second alternating pressure garment 920b, and a third alternating pressure garment 920c. Each of the alternating pressure garments 920a-c may be an Internet of Things (IoT) capable device, including an IoT chipset with at least one wireless transceiver, a mobile device manager and modem, and may be configured to communicate with a server 902 via a wireless network such as mobile network (e.g., 3G, LTE, 5G, etc.), or other protocol such as Wi-Fi. For example, the first alternating pressure garment 920a is configured to communicate with a mobile device 910 such as smart phone, tablet, laptop, etc., via Bluetooth link 914, and the mobile device 910 is configured to communicate with a base station 906 via network protocol (e.g., 3G, LTE, GSM, CDMA, OFDM, 5G, etc.). The second alternating pressure garment 920b may be configured to communicate with the base station 906 directed (e.g., it is mobile wireless capable). The third alternating pressure garment 920c is configured to communicate with a access point 918 via a WiFi link 922. The use of Bluetooth and WiFi are examples only and other wireless protocols may be used. In an example, the base station 906 may be a cellular base station, access point, femto cell, or other transceiver configured to connect the mobile device 910 and the alternating pressure garment 920b to the server 902 via the internet 904. The server 902 may be one or more computer systems including one or more processors, memory devices and peripheral devices configured to receive, store and send control variables for the alternating pressure garments 920a-c.

In an example, a weather station 924 may be configured to communicate with the access point 918 via wired or wireless link 924a. The weather station 924 may include a lightning detector and may be configured to provide weather and lightning data (including location information) to the server 902.

In operation, a pressure garment 920a-c may be configured using a networked computer such as a user interface application executing on the mobile device 910. The control unit 608 in each of the alternating pressure garments 920a-c is configured to receive or determine information about the utilization/application of an associated alternating pressure garment 920a-c. For example, a user may enter the breed, size, and other personal characteristics such as age and temperament of the canine that is wearing the alternating pressure garment. In an example, the control units 608 in the alternating pressure garments 920a-c may be configured to current environmental conditions such as a location (e.g., lat/long/alt), time and date, motion/activity and current environmental conditions based on sensors in the control unit 608 (e.g., accelerometers, temperature, barometric pressure sensor) or accessible via a connected weather station 924, or a web service (e.g., local weather status). The control unit 608 may also receive activity information from a paired mobile device 910. For example, the activity information may be based on signals from motion sensors such as the ST LSM6DSL chips configured to provide signals to the IoT chipset. The mobile device 910, or the control unit 608, may be configured to select one or more pump control parameters based on the application, environmental, and/or activity information. In an example a look-up table or similar data structure may persist on the mobile device 910 or within the control unit 608 to associate the application, environmental, and/or activity information with the pump timing parameters. In an example, the mobile device 910 or a control unit 608 may be configured to query the server 902 with the application, environmental, and/or activity information and receive the pump timing parameters from the server 902. While FIG. 9 depicts a single server 902, implementations may include multiple servers or cloud-based architectures such as Microsoft Azure® to receive, store and distribute application, environmental, activity information and/or pump timing parameters.

The network 900 enables the customization of the pump timing parameters for wide range of applications, environments and activities. The timing parameters may be varied for different applications (e.g., garment models, wearer identification) including variations within an application (e.g., size, breed, user preferences, home location, time of day). Current conditions such as environmental factors including the presence of lightning or the detection of other noises (e.g., fireworks) may be used to activate an alternating pressure garment. Other relationships between the application, environmental, and/or activity information and the pump timing parameters may also be used. In an example, a user may provide feedback via a mobile device regarding the effectiveness of particular pump parameters for an application, environmental, and/or activity information. A alternating pressure garment 920a-c may provide state information including current alternating pressure sensor readings and canine activity level (e.g., physiological measurements such as motion, sound, heartbeat) to the server 902. In this way, the pump timing parameters and alternating pressure sensor information may be crowdsourced, and effective parameters may be identified and more effectively disseminated to other users. In an example, users with network weather stations 924 may provide lightning information to the network, which may be utilized to activate nearby alternating pressure garments.

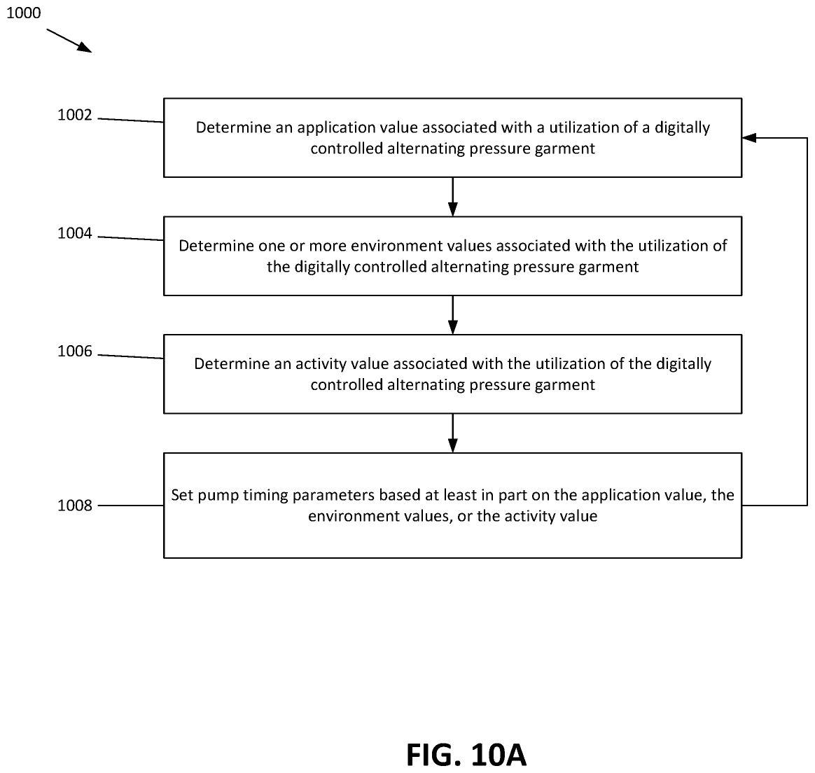

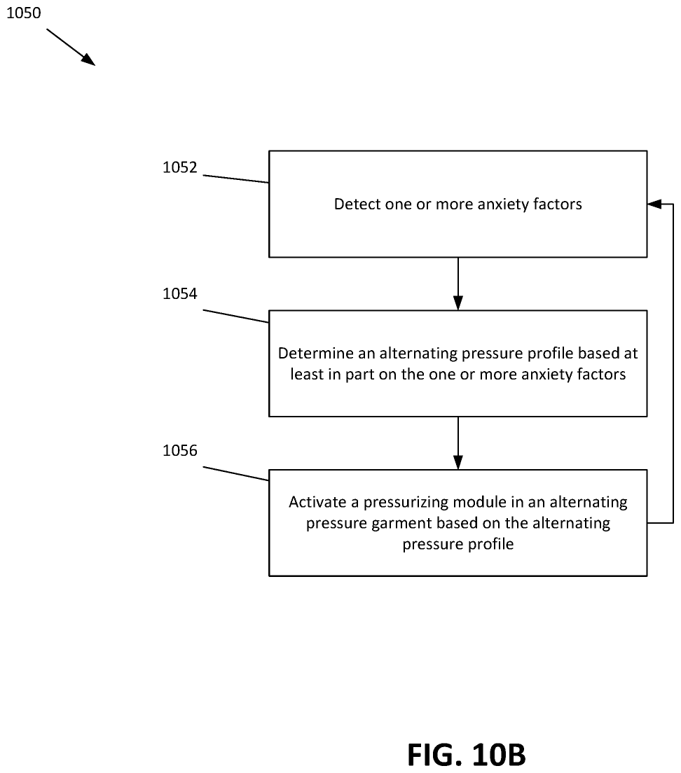

Referring to FIG. 10A, with further reference to FIGS. 1-9, a method 1000 of setting pump timing parameters in a digitally controlled alternating pressure garment includes the stages shown. The method 1000 is, however, an example only and not limiting. The method 1000 may be altered, e.g., by having stages added, removed, rearranged, combined, performed concurrently, and/or having single stages split into multiple stages.

At stage 1002, the method includes determining an application value associated with a utilization of a digitally controlled alternating pressure garment. A control unit 608 or a mobile device may be a means for determining an application value. In an example, a mobile device such as smart phone may be paired with an alternating pressure garment via a local communication protocol such as Bluetooth or WiFi. The alternating pressure garment may be configured at time of manufacture or may receive application values directly from a wireless network. Examples of the application value may be based information about the model and configuration of a particular alternating pressure garment (e.g., animal type, model number, bladder configuration), as well as the size of the garment (e.g., large, medium small). Information about the specific user (i.e., wearer) of the alternating pressure garment (e.g., unique ID value). Other categories and sub-categories may be used to describe a alternating pressure garment and may be associated with an application value.

At stage 1004, the method includes determining one or more environment values associated with the utilization of the digitally controlled alternating pressure garment. A control unit 608 or a mobile device may be a means for determining the one or more environment variables. The environment values may relate to a current context of the digitally controlled alternating pressure garment. For example, the current location, date, time and current weather conditions may be associated with environment values. Other context information such as the current speed, as well as ambient sounds and light intensity detected by sensors on the alternating pressure garment or the mobile device may be used to determine one or more environment variables. Other information available to the mobile device such as GPS position information, location tags (e.g., dog park, beach, hiking trail) and calendar entries may be used to determine the environment values. In general, the environment values describe where and when a digitally controlled alternating pressure garment is being used.

At stage 1006, the method includes determining an activity value associated with the utilization of the digitally controlled alternating pressure garment. The control unit 608 and sensors on the alternating pressure garment may be a means for determining an activity value. In an example, the control unit 608 may a 3D accelerometer and 3D gyroscope chip, such as the ST LSM6DSL may be operably coupled to an IoT chip set via a serial interface (e.g., I2C/SPI) and configured to provide motion information to a mobile device management module in the IoT chip set. The activity value may be based on current motion sensed by the control unit 608. The alternating pressure garment may include one or more sensors configured to detect motion as well as other environmental variables proximate to the canine 102 that is wearing the alternating pressure garment. For example, if the alternating pressure garment is being worn by a dog (i.e., alternating pressure garment 920a) that is actively moving and the mobile device 910 is being held by a user who is stationary, then activity value may indicate an active state. In general, the activity value indicates the context of the canine wearing the alternating pressure garment which may be different from the context of the mobile device.

At stage 1008, the method includes setting pump timing parameters based at least in part on the application value, the environment values, or the activity value. The control unit 608 in the alternating pressure garment may be a means for setting the pump timing parameters. The control unit 608 may include at least one processor and memory configured to store and access a data structure containing the pump timing parameters and associated application values, the environment values, and the activity values. In an example, a plurality of pump timing parameters and associated activity values may be stored in the control unit 608 at the time of manufacture. That is, the pump timing parameters may be based only on the activity values. In another example, a plurality of pump timing parameters and associated application, environment, and activity values may be stored in the control unit 608 at the time of manufacture or may be downloaded via the network 900. In operation, the control unit 608 may be configured to receive application and environment values from a networked system such as a mobile device 910 or server 902 (e.g., via Bluetooth, WiFi, etc.), and determine the pump timing parameters based on the previously stored values. In another example, a plurality of pump timing parameters and associated application, environment, and activity values may be received from a mobile device and stored in the control unit 608 when the alternating pressure garment 920a-c connects with the network 902. In another example, a mobile device 910 may be configured to provide a plurality of pump timing parameters and associated activity values to the alternating pressure garment based on the application and environment values determined by the mobile device.

Referring to FIG. 10B, with further reference to FIGS. 1-9, a method 1050 for activating a alternating pressure garment includes the stages shown. The method 1050 is, however, an example only and not limiting. The method 1050 may be altered, e.g., by having stages added, removed, rearranged, combined, performed concurrently, and/or having single stages split into multiple stages.

At stage 1052, the method includes detecting one or more anxiety factors. The control unit 608 may be a means for detecting the anxiety factors. The anxiety factors may correlate to one or more records in the example data structure 800 such as records in the environment class 804 and the activity class 806. The anxiety factors may be detectable activity (e.g., physiological) and environmental parameters such as a canine's current motion, emitted sound (e.g., bark, howl, whine, growl, sigh, groan), environmental sounds (e.g., thunder, fireworks, sirens), or other measurable parameters such as heartbeat, breath rate, and temperature. The control unit 608 may include, or be operably coupled to, one or more motion sensors (e.g., accelerometers, digital compass) configured to the detect the current motion of a canine 102. The current motion may be compared to threshold values (e.g., ActivityFactor) in the activity class 806 to indicate anxious behavior. For example, a rapid rocking motion (i.e., back and forth) may indicate the canine is scratching a door or window dressing with their forelegs, which is a common symptom of separation anxiety. Excessive jumping (i.e., up and down) may also be detected and determined to be an anxiety factor. The control unit 608 may include, or be operably coupled to, a microphone configured to detect current a sound level. Sound levels cause by barking, howling, whining, etc. may be compared to threshold values in the activity class 806 and used as anxiety factors. Combinations of motion, sounds, or other physiological parameters may be used as anxiety factors. In an example, the anxiety factor may be determined based on other input such as a lightning detection report or forecast from a weather station 924, or the sound of thunder detected by a microphone operably coupled the control unit 608. In an example, a user may indicate the anxiety factors via an interface such as with a connected mobile device. In this example, the user may initiate the pumping sequence based on available alternating pressure profiles. The user may also program a custom profile and observe the reaction. A reaction score may also to entered to assist categorizing the impact and desire for future use of the custom profile.

At stage 1054, the method includes determining an alternating pressure profile based at least in part on the one or more anxiety factors. The control unit 608 may be a means for determining an alternating pressure profile. In operation, the signals received from one or more of the motion sensors, microphone, or other sensors operably coupled to the control unit 608 may be compared to records in the data structure 800 stored in the control unit 608. One or more matching records in the application class 802, the environment class 804, and the activity class 806, may be used to determine pump cycles based on the pump parameters class 808. The alternating pressure profile is a record in the pump cycle class 810. In an example, the alternating pressure profile may include pump timing information and alternating pressure set point values.

At stage 1056, the method includes activating a pressurizing module in a alternating pressure garment based on the alternating pressure profile. The control unit 608 may be a means for activating the pressurizing module 602. The pressurizing module 602 includes one or more pumps 610 configured to inflate a plurality of bladders 616a-n, 620a-n. One or more pressure sensors 618a-n are operably coupled to the control unit 608 and configured to provide pressure feedback signals to control the pumps 610. In an example, the alternating pressure profile corresponds to one or more pressure functions 708a-b and/or pump states 710a-b depicted in FIG. 7. Different pressure functions and pump states may be used based on differing anxiety factors and the corresponding alternating pressure profiles. One or more alternating pressure profiles may be received from a network server 902 based on the anxiety factors. For example, the control unit 608 may be configure to query the network server 902 based on one or more anxiety factors and receive one or more alternating pressure profiles as the query results.

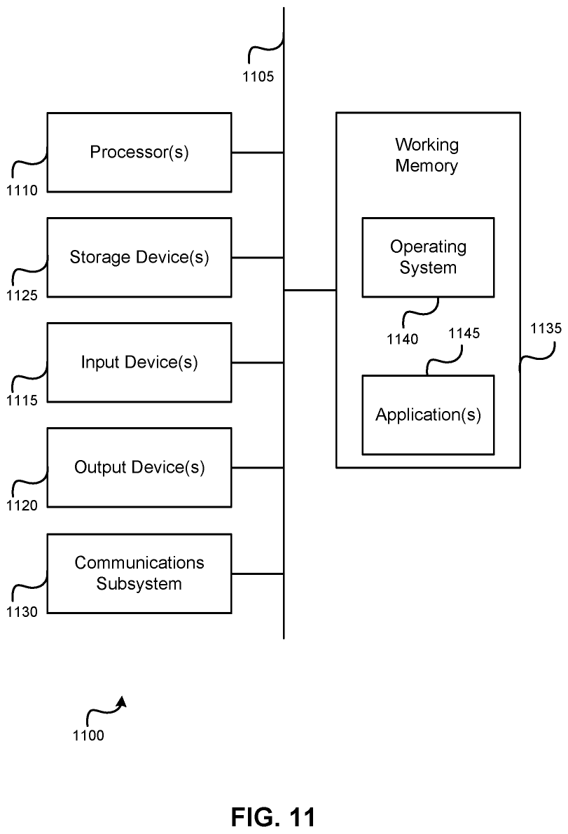

Referring to FIG. 11, an example computer system 1100 is shown. The computer system 1100 may be incorporated as part of the previously described computerized devices such as the server 902 and the control unit 608, and may be configured to perform the methods provided by various other embodiments, as described herein. It should be noted that FIG. 11 is meant only to provide a generalized illustration of various components, any or all of which may be utilized as appropriate. FIG. 11, therefore, broadly illustrates how individual system elements may be implemented in a relatively separated or relatively more integrated manner.

The computer system 1100 is shown comprising hardware elements that can be electrically coupled via a bus 1105 (or may otherwise be in communication, as appropriate). The hardware elements may include one or more processors 1110, including without limitation one or more general-purpose processors and/or one or more special-purpose processors (such as digital signal processing chips, graphics acceleration processors, and/or the like); one or more input devices 1115, which can include without limitation a mouse, a keyboard and/or the like; and one or more output devices 1120, which can include without limitation a display device, a printer and/or the like.

The computer system 1100 may further include (and/or be in communication with) one or more non-transitory storage devices 1125, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 1100 might also include a communications subsystem 1130, which can include without limitation a modem, a network card (wireless or wired), an infrared communication device, a wireless communication device and/or chipset (such as a Bluetooth device, an 802.11 device, a WiFi device, a WiMax device, cellular communication facilities, etc.), and/or the like. The communications subsystem 1130 may permit data to be exchanged with a network (such as the network described below, to name one example), other computer systems, and/or any other devices described herein. In many embodiments, the computer system 1100 will further comprise a working memory 1135, which can include a RAM or ROM device, as described above.

The computer system 1100 also can comprise software elements, shown as being currently located within the working memory 1135, including an operating system 1140, device drivers, executable libraries, and/or other code, such as one or more application programs 1145, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 1125 described above. In some cases, the storage medium might be incorporated within a computer system, such as the system 1100. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 2200 and/or might take the form of source and/or installable code, which, upon compilation and/or installation on the computer system 1100 (e.g., using any of a variety of generally available compilers, installation programs, alternating pressure/de-alternating pressure utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 1100) to perform methods in accordance with various embodiments of the invention. According to a set of embodiments, some or all of the procedures of such methods are performed by the computer system 1100 in response to processor 1110 executing one or more sequences of one or more instructions (which might be incorporated into the operating system 1140 and/or other code, such as an application program 1145) contained in the working memory 1135. Such instructions may be read into the working memory 1135 from another computer-readable medium, such as one or more of the storage device(s) 1125. Merely by way of example, execution of the sequences of instructions contained in the working memory 1135 might cause the processor(s) 1110 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 1100, various computer-readable media might be involved in providing instructions/code to processor(s) 1110 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 1125. Volatile media include, without limitation, dynamic memory, such as the working memory 1135. Transmission media include, without limitation, coaxial cables, copper wire and fiber optics, including the wires that comprise the bus 1105, as well as the various components of the communication subsystem 1130 (and/or the media by which the communications subsystem 1130 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 1110 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1100. These signals, which might be in the form of electromagnetic signals, acoustic signals, optical signals and/or the like, are all examples of carrier waves on which instructions can be encoded, in accordance with various embodiments of the invention.

The communications subsystem 1130 (and/or components thereof) generally will receive the signals, and the bus 1105 then might carry the signals (and/or the data, instructions, etc. carried by the signals) to the working memory 1135, from which the processor(s) 1105 retrieves and executes the instructions. The instructions received by the working memory 1135 may optionally be stored on a storage device 1125 either before or after execution by the processor(s) 1110.

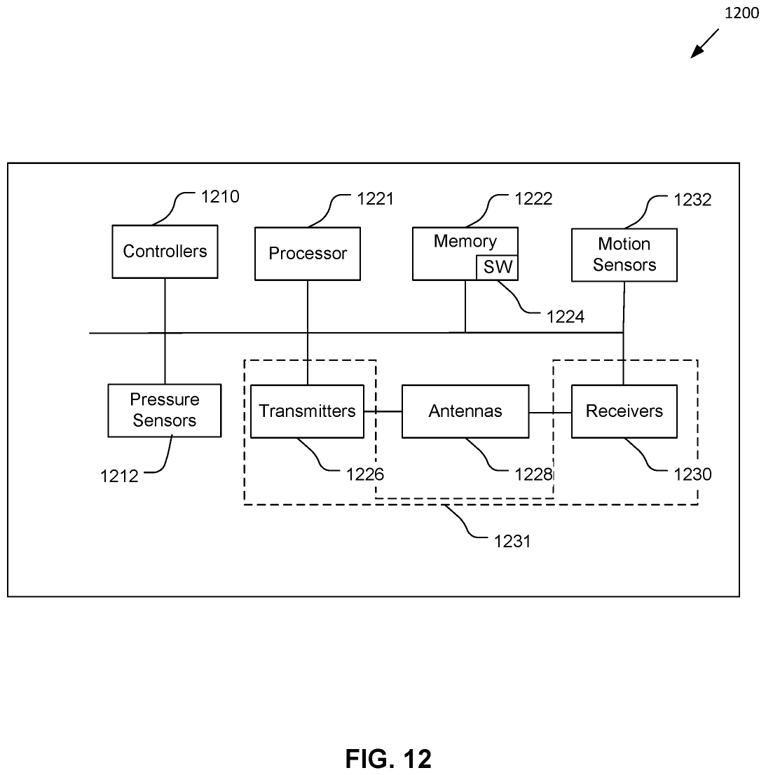

Referring to FIG. 12, an example control unit 1200 in a digitally controlled pressure garment is shown. The control unit 1200 is an example of the control unit 608. The control unit 1200 comprises a computer system including controllers 1210, pressure sensors 1212, a processor 1221, memory 1222 including software 1224, a transceiver 1226, antennas 1228, receivers 1230, and motion sensors 1232. The transceiver 1226 and antennas 1228 form a wireless communication module that can communicate bi-directionally with the mobile device 910, the base station 906, and access point 918 and/or another entity. Thus, the antennas 1228 may include appropriate antennas for communicating with the mobile device 910, base station 906 and the access point 918, and the transceiver 1226 may include multiple transceivers for communication with the mobile device 910, the base station 906, and/or the access point 918. The antennas 1228 may include a satellite positioning system (SPS) antenna for receiving SPS signals and the transceiver 1226 may include an SPS receiver for processing and transferring the SPS signals to the processor 1221. The processor 1221 is preferably an intelligent hardware device, e.g., a central processing unit (CPU) such as those made by ARM®, Intel® Corporation, or AMD®, a microcontroller, an application specific integrated circuit (ASIC), etc. The processor 1221 could comprise multiple separate physical entities that can be distributed in the mobile device 1200. The memory 1222 includes random access memory (RAM) and read-only memory (ROM). The memory 1222 is a processor-readable storage medium that stores the software 1224 which is processor-readable, processor-executable software code containing processor-readable instructions that are configured to, when executed, cause the processor 1221 to perform various functions described herein (although the description may refer only to the processor 1221 performing the functions). Alternatively, the software 1224 may not be directly executable by the processor 1221 but configured to cause the processor 1221, e.g., when compiled and executed, to perform the functions.

The controllers 1210 are operably to the pumps 610 and configured to active the pumps 610 based on pump timing and other signals provided by the processor 1221. In an embodiment, the controllers 1210 may be operably coupled to one or more bleed valves configured to allow pressure to release air from the bladders 616a-n, 620a-n, manifolds 614a-b, or at other points within the pressure distribution system 600. The pressure sensors 1212 may be the pressure sensors 618a-n and/or the pressure sensors 612a-j. The pressure sensors 1212 are configured to provide pressure signals to the processor 1221. The pressure signals may be used for controlling the pumps 610. In an example, an IoT chipset may be configured to perform one or more functions of the control unit 1200.

Other examples and implementations are within the scope and spirit of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

In an aspect, the alternating pressure garment 100 incorporates adjustable air bladders within the alternating pressure garment to provide a physical means of supplying therapeutic therapy to an animal and avoid sensory adaptation. Adjustment of the inflation and deflation modalities for the air bladder system induces applied and variable pressure sensations on the exterior of an animal thereby providing the therapeutic effect. In addition to the variable pressure aspect of the air bladders, the physical location of the air bladders in relation to the animal's body may also have a direct impact on the therapeutic benefit.

In an aspect, the alternating pressure garment 100 provides intermittent or variable calming therapy to a companion animal based on the monitored activity, physiological state, or surrounding environment of the animal. For example, with increased agitation detected by the digital monitoring system, inflation of the air bladders can occur which in turn applies a comforting pressure to animal's exterior immediately after the onset of the agitation and subsequently be varied to avoid sensory adaptation. This is a distinction from other methods which rely on a constant application of pressure via a tightly fitted compression garment. While perhaps providing some initial benefit from wearing a compression garment, it is expected that an animal would undergo sensory adaptation and become used to or adapt to the presence of the compression garment. However, using periodic and alternating application of pressure to the surface of the animal immediately after or during the agitation cycle has not been cited and is expected to provide a vastly improved therapeutic benefit by avoiding sensory adaptation. Once a change in the agitation (e.g., decreased agitation) of the animal is detected via the monitored activity of the wearer, the applied pressure can be reduced to its initial state resetting the alternating pressure garment for the next agitation cycle. In addition, any number of variable inflation and deflation cycling modalities for the bladders can be achieved with the device to ensure sensory adaptation is not experienced by the animal wearing the device. For example, a simple repeated inflation sequence followed by a delay without requiring monitoring devices or pressure sensors can also avoid some level of sensory adaptation. Furthermore, different individual bladders or subsets of bladders can be inflated and/or deflated in any combination which ensures a changing body surface pressure location experience for the canine thereby avoiding sensory adaptation. These attributes differ from the current state-of-art for constant pressure compression garments which confer no change in pressure, no alternating location specificity of applied pressure, and no time-based, agitation dependent therapeutic benefit. Based on sensory adaptation to the consistent, non-varying stimulation of touch provided by constant pressure compression garments, it is expected that these prior art garments would provide little to no long-term calming benefit.

In an aspect, the alternating pressure garment 100 incorporates sensors for monitoring the activity, physiological state, or environment of the wearer to enable periodic or on-demand therapeutic benefit. In the case of increased activity detected due to agitation of the wearer, several localized parameter changes (i.e., directly associated with physical or physiological disposition of the wearer) can be detected by various sensors. These parameter changes may present themselves as increased heartrate, respiration, movement, changes in relative position, etc. each of which can be detected by sensors in communication with the digital control module. These localized sensors can be embedded digital sensors within the digital control module, be present as peripheral sensors on the wearable garment, or be present on another device worn by the animal and in communication with the digital control module. Once the appropriate digital signals from the sensors are received by the digital control module, any number of activation profiles can be invoked to execute inflation and deflation profiles for the embedded air bladders.

In an aspect, the alternating pressure garment 100 incorporates pressure sensors into the alternating pressure garment to maintain or establish a targeted therapeutic effect. For example, pressure sensors can be integrated into the air bladders or the garment material between the air bladder and the outer surface of the animal. These pressure sensors may be in communication with the digital control module and thereby provide feedback for initiating specific inflation or deflation actions.

In an aspect, the alternating pressure garment 100 incorporates Bluetooth, WiFi, or other wireless communication means with the digital control module to enable additional operation modes of the digital control module. In this use case, a Bluetooth-enabled or other wireless application with commands, set points, cycle times, duration, and other parameters is used to drive activity of the digital control module and establish the inflation and deflation for the air bladders. This wireless communication mode can work in conjunction with embedded sensors within the digital control module, in conjunction with peripheral sensors in communication with the digital control module, bypass all of the embedded or peripheral sensors, or any combination thereof. In this external communication method, a customizable inflation and deflation operational mode for the air bladders can be derived depending on intended outcome, familiarity with the companion animal, or other factors.

In an aspect, the alternating pressure garment 100 utilizes peripheral sensors such as lightning detectors, sound detectors, and other environmental condition sensors to initiate inflation and deflation operation of the air bladders. In this case, the peripheral detector or sensor may be in communication with the device directly (wired) and/or via Bluetooth or other wireless communication means. In another example, the peripheral detector or sensor is in communication with an application which can alert the owner to initiate a particular inflation and deflation protocol for the device and initiate calming therapy.

In an aspect, the alternating pressure garment 100 may allow for pre-programmed inflation and deflation operation of the digital control module which in turn drives a specific inflation and deflation operation mode for the air bladders. This pre-programmed operation mode with specific periods, cycle times, durations, and other time-based inflation and deflation parameters for the air bladders would invoke a repeatable, consistent therapeutic treatment. The pre-programmed inflation and deflation protocol may be resident within the digital control module firmware or downloaded or otherwise transferred to the digital control module by Bluetooth or other wireless communication means.

In an aspect, the alternating pressure garment 100 utilizes various deflation means of the pressurized air bladders. For example, deflation of the pressurized air bladders can be accomplished via a multitude of methodologies including vacuum pumps, bleed-off valves, bleed-off materials integrated into the assembly, air displacement ballasts, manifolds, inherent loss of pressure through the system, or any other means of fluidic transfer from the pressurized air bladders. Controlling deflation by a variety of methods provides flexibility for the therapeutic treatment. For example, tuning the deflation to rapidly occur after prolonged detectable resting (a potential sign of reduced anxiety) or reduced heart rate can be accomplished with a vacuum pump. In another example, slowly cycling inflation and deflation modes may be more desirable and can be accomplished with a slow bleed-off valve for the deflation mode.

In an aspect, the alternating pressure garment 100 may work in conjunction with existing third-party canine monitoring systems. In this case, the third-party canine monitoring system is treated as a peripheral device and is in communication with the wearable alternating pressure garment either via the digital control module or the wireless communication method such as Bluetooth.

In an aspect, the alternating pressure garment 100 may allow for a general method approach for anxiety reduction therapy based on inputs from multiple data sources. These data sources may be from the alternating pressure garment itself such as the environment, activity profiles, or physiological profiles, from existing animal monitoring devices on the market, from input by veterinarians or other animal welfare organizations familiar with anxiety reduction protocols, from input by a veterinarian associated with the specific animal, from peripheral devices, or any other data source that may provide information for tailoring an anxiety reduction therapy using the digitally controlled alternating pressure garment. In this general method approach, any single or combination of these data sources can be utilized to initiate tailored inflation and deflation operation of the air bladders and thereby provide a customizable anxiety reduction therapy.

In an aspect, the alternating pressure garment 100 may apply a specific therapeutic treatment based on detected physiological changes based on inputs from multiple data sources. These data sources may be from sensors within alternating pressure garment or from existing animal monitoring devices. As an example, sensor detecting increased heart rate, respiration rate, or localized carbon dioxide concentration, would reflect an increased agitation for the animal and thus may be used as triggers to initiate therapeutic treatment. Another example may involve communication from another animal monitoring device worn capable of monitoring physiological status and in communication with the digital control module of the alternating pressure garment.

Also, as used herein, “or” as used in a list of items prefaced by “at least one of” or prefaced by “one or more of” indicates a disjunctive list such that, for example, a list of “at least one of A, B, or C,” or a list of “one or more of A, B, or C,” or “A, B, or C, or a combination thereof” means A or B or C or AB or AC or BC or ABC (i.e., A and B and C), or combinations with more than one feature (e.g., AA, AAB, ABBC, etc.).

As used herein, unless otherwise stated, a statement that a function or operation is “based on” an item or condition means that the function or operation is based on the stated item or condition and may be based on one or more items and/or conditions in addition to the stated item or condition.

Further, an indication that information is sent or transmitted, or a statement of sending or transmitting information, “to” an entity does not require completion of the communication. Such indications or statements include situations where the information is conveyed from a sending entity but does not reach an intended recipient of the information. The intended recipient, even if not actually receiving the information, may still be referred to as a receiving entity, e.g., a receiving execution environment. Further, an entity that is configured to send or transmit information “to” an intended recipient is not required to be configured to complete the delivery of the information to the intended recipient. For example, the entity may provide the information, with an indication of the intended recipient, to another entity that is capable of forwarding the information along with an indication of the intended recipient.

A wireless communication system is one in which at least some communications are conveyed wirelessly, e.g., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or evenly primarily, for communication, or that the device be a mobile device, but indicates that the device includes wireless communication capability (one-way or two-way), e.g., includes at least one radio (each radio being part of a transmitter, receiver, or transceiver) for wireless communication.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, some operations may be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform one or more of the described tasks.

Components, functional or otherwise, shown in the figures and/or discussed herein as being connected, coupled (e.g., communicatively coupled), or communicating with each other are operably coupled. That is, they may be directly or indirectly, wired and/or wirelessly, connected to enable signal transmission between them.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

“About” and/or “approximately” as used herein when referring to a measurable value such as an amount, a temporal duration, and the like, encompasses variations of ±20% or ±10%, ±5%, or +0.1% from the specified value, as appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

Further, more than one invention may be disclosed.

1. An alternating pressure garment, comprising:
a fabric or polymeric shell configured to fit around at least a portion of a companion animal;
one or more fasteners configured to secure the fabric or polymeric shell around the companion animal;
a plurality of bladders disposed between the fabric or polymeric shell and the companion animal; and
a pressurizing module fluidly coupled to the plurality of bladders and configured to alternately pressurize at least a first group of the plurality of bladders and a second group of the plurality bladders, such that the first group of the plurality of bladders is in an inflated state and the second group of the plurality of bladders is in a deflated state or the first group of the plurality of bladders is in a deflated state and the second group of the plurality of bladders is in an inflated state.

2. The alternating pressure garment of claim 1 further comprising one or more pressure sensors operably coupled to the pressurizing module configured to sense a pressure between one or more of the plurality of bladders and the companion animal.

3. The alternating pressure garment of claim 1 further comprising one or more pressure sensors operably coupled to the pressurizing module configured to sense an air pressure in one or more of the plurality of bladders.

4. The alternating pressure garment of claim 1 wherein the pressurizing module is configured to generate a vacuum pressure to deflate one or more of the plurality of bladders.

5. The alternating pressure garment of claim 1 further comprising one or more bleed orifices configured to release pressure from the plurality of bladders.

6. The alternating pressure garment of claim 1 wherein the pressurizing module comprises a control unit configured to alternately pressurize the plurality of bladders based on one or more pressure functions.

7. The alternating pressure garment of claim 6 wherein pressure functions cause the first group of the plurality of bladders and the second group of the plurality of bladders to alternately inflate and deflate periodically.

8. The alternating pressure garment of claim 6 wherein pressure functions cause the first group of the plurality of bladders and the second group of the plurality of bladders to alternately inflate and deflate randomly.

9. The alternating pressure garment of claim 6 wherein the control unit further comprises a wireless communication module configured to receive the one or more pressure functions via a wireless network.

10. A method for reducing anxiety in a companion animal with an alternating pressure garment, comprising:
detecting one or more anxiety factors;
determining an alternating pressure profile based at least in part on the one or more anxiety factors; and
activating a pressurizing module in the alternating pressure garment based on the alternating pressure profile.

11. The method of claim 10 wherein the one or more anxiety factors are associated with the companion animal.

12. The method of claim 11 wherein the one or more anxiety factors are determined from one of a group consisting of a motion sensor, a heart-beat sensor, and a microphone.

13. The method of claim 10 wherein the one or more anxiety factors are associated with an environment around the companion animal.

14. The method of claim 13 wherein the one or more anxiety factors are determined from one of a group consisting of a weather station, a microphone, and a user input.

15. The method of claim 10 wherein determining the alternating pressure profile includes querying a data structure based on the one or more anxiety factors.

16. The method of claim 10 wherein determining the alternating pressure profile includes receiving a custom profile from a user.

17. The method of claim 10 wherein activating the pressurizing module comprises:
alternately inflating and deflating a first group of bladders in the alternating pressure garment; and
alternately inflating and deflating at least a second group of bladders in the alternating pressure garment;
wherein the first group of bladders is inflated when at least the second group of bladders is deflated.

18. A system for setting pump parameters for an alternating pressure garment, comprising:
a memory;
at least one processor operably coupled to the memory and configured to:
determine an application value associated with a utilization of the alternating pressure garment;
determine one or more environment values associated with the utilization of the alternating pressure garment;
determine an activity value associated with the utilization of the alternating pressure garment; and
set pump timing parameters based at least in part on the application value, the one or more environment values, or the activity value.

19. The system of claim 18 further comprising a communication module operably coupled to the at least one processor and configured to receive the application value, the one or more environment values, or the activity value via a network.

20. The system of claim 19 wherein the communication module is further configured to provide the pump timing parameters to the network.

21. An alternating pressure garment, comprising:
a fabric or polymeric shell configured to fit around at least a portion of a companion animal;
one or more fasteners configured to secure the fabric or polymeric shell around the companion animal;
a plurality of bladders disposed between the fabric or polymeric shell and the companion animal; and
a pressurizing module fluidly coupled to the plurality of bladders and configured to alternately pressurize and depressurize the plurality of bladders.

22. The alternating pressure garment of claim 21 wherein the pressurizing module comprises a control unit configured to alternately pressurize the plurality of bladders based on one or more pressure functions.

23. The alternating pressure garment of claim 22 wherein the one or more pressure functions cause the plurality of bladders alternately inflate and deflate periodically.

24. The alternating pressure garment of claim 22 wherein the one or more pressure functions cause the plurality of bladders to alternately inflate and deflate randomly.

25. The alternating pressure garment of claim 22 wherein the control unit further comprises a wireless communication module configured to receive the one or more pressure functions via a wireless network.
